(19) United States
(12) Patent Application Publication
(10) Pub. No.: US 2023/0056706 A1
(43) Pub. Date: Feb. 23, 2023

(54) SYSTEMS AND METHODS FOR PROVIDING DATA PRIVACY USING FEDERATED LEARNING

(71) Applicant: Digitalware, Inc., New York, NY (US)

(72) Inventors: Damion Irving, Brooklyn, NY (US); James Korge, Brooklyn, NY (US); Jeffrey L. Thomas, Columbus, OH (US); Donald Bathurst, Denver, CO (US)

(21) Appl. No.: 17/816,163

(22) Filed: Jul. 29, 2022

Related U.S. Application Data
(60) Provisional application No. 63/234,557, filed on Aug. 18, 2021.

(51) Int. Cl. G06N 3/08; G06N 3/04; H04L 9/40

(52) U.S. Cl. CPC G06N 3/08; G06N 3/0454; H04L 63/04

(57) ABSTRACT

Data privacy using federated learning is provided by receiving one or more instance(s) of a master RL agent model and training the instance(s) of the master RL agent model on a corresponding graph, thereby generating corresponding sets of RL model weights. One or more information gains corresponding to one or more software stacks are generated. The information gain(s) and the RL model weight(s) are transmitted to a central server to enable the central server to update the master RL agent model based on the information gain(s) and the RL model weights.

### CROSS REFERENCE TO RELATED APPLICATION

This application claims priority to, and the benefit of, U.S. Provisional Patent Application Ser. No. 63/234,557, filed Aug. 18, 2021, which is hereby incorporated by reference in its entirety.

### TECHNICAL FIELD

Example aspects described herein relate generally to network security, and more particularly to the field of cybersecurity and threat analytics and prevention.

### BACKGROUND

It is commonly known that computing assets within a computer network can be susceptible to data breaches or attacks based on malicious users gaining unauthorized access to one or more assets with the network. In such computer networks, a vulnerability can be defined as a vulnerability in software, hardware, firmware, etc. that can be exploited to gain access to certain resources. Risks can come from technical failures, process breakdowns, and sloppy information technology (IT) practices anywhere within a computer network.

The transmission of data in a network is oftentimes described in terms of whether the data is “in transit” or “at rest”. Data in transit, also referred to as data in motion, is data actively moving from one location to another such as across the internet or through a private network. Data protection in transit is the protection of this data while it is traveling from network to network or being transferred from a local device such as a local storage device to a remote device such as a cloud storage device. Wherever data is moving, effective data protection measures for in transit data are critical as data is often considered less secure while in transit.

Data at rest is data that is not actively moving from device to device or network to network, such as data stored on a hard drive, laptop, flash drive, or archived/stored in some other way. Data protection at rest aims to secure inactive data stored on any device or network. While data at rest is sometimes considered to be less vulnerable than data in transit, attackers often find data at rest a more valuable target than data in transit. The risk profile for data in transit or data at rest depends on the security measures that are in place to secure data in either state.

Protecting sensitive data both in transit and at rest is imperative for modern enterprises as attackers find increasingly innovative ways to compromise systems and steal data.

A graph database uses highly inter-linked data structures built from nodes, relationships, and properties. Graph structures can support sophisticated, semantically rich queries at scale.

A data silo (referred to sometimes simply as a silo) is an information management system or device that is unable to freely communicate with other such systems or devices. Communication within data silos is typically vertical, making it difficult or impossible for the system or device to work with unrelated systems and devices. A data silo is disconnected and prevents larger structures from being composed easily. Consequently, data silos mean that the datasets in each silo are unconnected. Similarly, the software stacks that support silos, such as with regard to machine learning inferencing, embedding generation, path generation (e.g., based on the inferencing), and the logic that that is used to send such data to a graphics processing unit (GPU) server is siloed as well. That is, there is no crosstalk between client software stacks, which as explained above makes it difficult or impossible to work with each other.

Data science applications are oftentimes used to battle data privacy. In the event that personally identifiable information (PII) is included in a dataset, efforts must be taken to protect this data in transit and at rest. In the event that a machine learning agent, such as a reinforcement learning agent. is used to learn from siloed client datasets, it would be desirable to use a design framework that prevents data leakage.

For any neural network, the training phase of the deep learning model is the most resource-intensive task. In a typical neural network, while training, a neural network receives input. These inputs are, in turn, then processed in hidden layers using weights that are adjusted during training. The model then outputs a prediction. Weights are adjusted to find patterns in order to make better predictions. These operations are oftentimes essentially in the form of matrix multiplications, where the first array is the input to the neural network and the second array forms its weight. However, neural networks can have billions of parameters. While GPUs can be used for training artificial intelligence and deep learning models because of their ability to process multiple computations simultaneously, there is a need to utilize GPUs more efficiently. There is also a need to keep data such as PII that is processed by GPUs as secure as possible.

### SUMMARY

The example embodiments described herein meet the above-identified needs by providing methods, systems and computer program products for applying a federated learning framework to preserve siloed client data privacy. In an example embodiment, a machine learning agent (e.g., a reinforcement learning (RL) agent) is used to learn from siloed client datasets.

In one aspect of the disclosure, a method for providing data privacy using federated learning may involve: receiving a first instance of a master RL agent model; training the first instance of the master RL agent model on a first graph, thereby generating a first set of RL model weights; generating a first information gain corresponding to a first software stack of a first client; and transmitting the first information gain and the first set of RL model weights to a central server to enable the central server to update the master RL agent model based on the first information gain and the first set of RL model weights.

In some embodiments, the method further involves updating the master RL agent model based on the first information gain and the first set of RL model weights, thereby generating an updated master RL agent model. In some embodiments, the method further involves receiving an updated master RL agent model and training the updated master RL agent model on another graph.

In some embodiments, the method further involves receiving a second instance of the master RL agent model; training the second instance of the master RL agent model on a second graph, thereby generating a second set of RL model weights; generating a second information gain corresponding to a second software stack of a second client; and transmitting the second information gain and the second RL model weights to the central server to enable the central server to update the master RL agent model based on the first information gain, the first set of RL model weights, the second information gain and the second set of RL model weights. In some embodiments, the method further involves updating the master RL agent model based on the first information gain, the first set of RL model weights, the second information gain and the second set of RL model weights, thereby generating an updated master RL agent model.

In some embodiments, each of the first software stack and the second software stack are siloed.

In some embodiments, the method further involves combining the first set of RL model weights and the second set of RL model weights to generate a combined set of RL model weights. In some embodiments, the method further involves updating the master RL agent model by applying the combined set of RL model weights. In some embodiments, the method further involves updating the master RL agent model by applying a weighted average based on the first information gain and the second information gain.

Another aspect of the disclosure involves a non-transitory computer-readable medium having stored thereon sequences of instructions, the sequences of instructions including instructions which when executed by a computer system causes the computer system to perform: receiving a first instance of a master RL agent model; training the first instance of the master RL agent model on a first graph, thereby generating a first set of RL model weights; generating a first information gain corresponding to a first software stack of a first client; and transmitting the first information gain and the first set of RL model weights to a central server to enable the central server to update the master RL agent model based on the first information gain and the first set of RL model weights.

In some embodiments, the non-transitory computer-readable medium, further has stored thereon a sequence of instructions for causing the one or more processors to perform updating the master RL agent model based on the first information gain and the first set of RL model weights, thereby generating an updated master RL agent model.

In some embodiments, the non-transitory computer-readable medium, further has stored thereon a sequence of instructions for causing the one or more processors to perform receiving an updated master RL agent model; and training the updated master RL agent model on another graph.

In some embodiments, the non-transitory computer-readable medium, further has stored thereon a sequence of instructions for causing the one or more processors to perform: receiving a second instance of the master RL agent model; training the second instance of the master RL agent model on a second graph, thereby generating a second set of RL model weights; generating a second information gain corresponding to a second software stack of a second client; and transmitting the second information gain and the second RL model weights to the central server to enable the central server to update the master RL agent model based on the first information gain, the first set of RL model weights, the second information gain and the second set of RL model weights. In some embodiments, the non-transitory computer-readable medium, further has stored thereon a sequence of instructions for causing the one or more processors to perform updating the master RL agent model based on the first information gain, the first set of RL model weights, the second information gain and the second set of RL model weights, thereby generating an updated master RL agent model.

In some embodiments, each of the first software stack and the second software stack are siloed.

In some embodiments, the non-transitory computer-readable medium, further has stored thereon a sequence of instructions for causing the one or more processors to perform combining the first set of RL model weights and the second set of RL model weights to generate a combined set of RL model weights. In some embodiments, the non-transitory computer-readable medium, further has stored thereon a sequence of instructions for causing the one or more processors to perform updating the master RL agent model by applying the combined set of RL model weights.

In some embodiments, the non-transitory computer-readable medium, further has stored thereon a sequence of instructions for causing the one or more processors to perform updating the master RL agent model by applying a weighted average based on the first information gain and the second information gain.

In another aspect of the disclosure a federated learning data privacy system may involve: a first agent server having a first neural network configured to: receive a first instance of a master RL agent model, and train, by the first neural network the first instance of the master RL agent model on one of a plurality of graphs, thereby generating a first set of RL model weights; and a first information gain calculator communicatively coupled to the first agent server and to a central server, configured to: generate a first information gain corresponding to a first software stack of a first client, and transmit the first information gain and the first set of RL model weights to the central server to enable the central server to update the master RL agent model based on the first information gain and the first set of RL model weights.

In some embodiments, the central server is configured to update the master RL agent model based on the first information gain and the first set of RL model weights, thereby generating an updated master RL agent model.

In some embodiments, the first agent server is configured to receive an updated master RL agent model; and the first neural network is configured to train the updated master RL agent model on another one of the plurality of graphs.

In some embodiments, the system may further involve a second agent server having a second neural network, configured to: receive a second instance of the master RL agent model and train the second instance of the master RL agent model on a second graph, thereby generating a second set of RL model weights; and a second information gain calculator further configured to: generate a second information gain corresponding to a second software stack of a second client, and transmit the second information gain and the second RL model weights to the central server to enable the central server to update the master RL agent model based on the first information gain, the first set of RL model weights, the second information gain and the second set of RL model weights. In some embodiments the central server is further configured to update the master RL agent model based on the first information gain, the first set of RL model weights, the second information gain and the second set of RL model weights, thereby generating an updated master RL agent model.

In some embodiments, each of the first software stack and the second software stack are siloed.

In some embodiments, the system may further involve a weighted average calculator configured to combine the first set of RL model weights and the second set of RL model weights to generate a combined set of RL model weights.

In some embodiments, the weighted average calculator is configured to update the master RL agent model by applying the combined set of RL model weights.

In some embodiments, the system may further involve a weighted average calculator configured to update the master RL agent model by applying a weighted average based on the first information gain and the second information gain.

In some embodiments, the first agent server and the second agent server are on different systems.

In some embodiments, the first agent server and the second agent server are on the same system.

In another aspect of the disclosure, a method for providing data privacy using federated learning may involve: transmitting a first instance of a master RL agent model to a first agent server; receiving a first information gain from a first information gain calculator, wherein the first information gain corresponds to a first software stack of a first client; receiving a first set of RL model weights from the first agent server, wherein the first set of RL model weights corresponds to a training of a first instance of the master RL agent model on a first graph; and updating the master RL agent model based on the first information gain and the first set of RL model weights, thereby generating an updated master RL agent model.

In some embodiments, the method further involves transmitting the updated master RL agent model to the first agent server to train the updated master RL agent model on another graph.

In some embodiments, the method further involves transmitting a second instance of the master RL agent model to a second agent server; receiving a second information gain from a second gain calculator wherein the second information gain corresponds to a second software stack of a second client; receiving a second set of RL model weights from the second agent server, wherein the second set of RL model weights corresponds to a training of the second instance of the master RL agent model on a second graph; and updating the master RL agent model based the first information gain, the first set of RL model weights, the second information gain and the second set of RL model weights, thereby generating an updated master RL agent model. In some embodiments, the method further involves transmitting the updated master RL agent model to the first agent server and to the second agent server to each train the updated master RL agent model on another graph, correspondingly.

In some embodiments, the method further involves combining the first set of RL model weights and the second set of RL model weights to generate a combined set of RL model weights. In some embodiments, the method further involves updating the master RL agent model by applying the combined set of RL model weights.

In some embodiments, the method further involves updating the master RL agent model by applying a weighted average based on the first information gain and the second information gain.

In another aspect of the disclosure, there is provided a non-transitory computer-readable medium having stored thereon sequences of instructions, the sequences of instructions including instructions which when executed by a computer system causes the computer system to perform: transmitting a first instance of a master RL agent model to a first agent server; receiving a first information gain from a first gain calculator, wherein the first information gain corresponds to a first software stack of a first client; receiving a first set of RL model weights from the first agent server, wherein the first set of RL model weights corresponds to a training of a first instance of the master RL agent model on a first graph; and updating the master RL agent model based on the first information gain and the first set of RL model weights, thereby generating an updated master RL agent model.

In some embodiments, the non-transitory computer-readable medium further has stored thereon a sequence of instructions for causing the one or more processors to perform transmitting the updated master RL agent model to a first agent server to train the updated master RL agent model on another graph.

In some embodiments, the non-transitory computer-readable medium further has stored thereon a sequence of instructions for causing the one or more processors to perform transmitting a second instance of the master RL agent model to a second agent server; receiving a second information gain from a second gain calculator wherein the second information gain corresponds to a second software stack of a second client; receiving a second set of RL model weights from the second agent server, wherein the second set of RL model weights corresponds to a training of the second instance of the master RL agent model on a second graph; and updating the master RL agent model based the first information gain, the first set of RL model weights, the second information gain and the second set of RL model weights, thereby generating an updated master RL agent model.

In some embodiments, the non-transitory computer-readable medium further has stored thereon a sequence of instructions for causing the one or more processors to perform transmitting the updated master RL agent model to the first agent server and to the second agent server to each train the updated master RL agent model on another graph, correspondingly.

In some embodiments, the non-transitory computer-readable medium further has stored thereon a sequence of instructions for causing the one or more processors to perform updating the master RL agent model based on the first information gain, the first set of RL model weights, the second information gain and the second set of RL model weights, thereby generating an updated master RL agent model.

In some embodiments, the non-transitory computer-readable medium further has stored thereon a sequence of instructions for causing the one or more processors to perform combining the first set of RL model weights and the second set of RL model weights to generate a combined set of RL model weights.

In some embodiments, the non-transitory computer-readable medium further has stored thereon a sequence of instructions for causing the one or more processors to perform updating the master RL agent model by applying the combined set of RL model weights.

In some embodiments, the non-transitory computer-readable medium further has stored thereon a sequence of instructions for causing the one or more processors to perform updating the master RL agent model by applying a weighted average based on the first information gain and the second information gain.

Another aspect of the embodiments provides a federated learning data privacy system that may involve a central server configured to: transmit a first instance of a master RL agent model to a first agent server; receive a first information gain from a first gain calculator, wherein the first information gain corresponds to a first software stack of a first client; receive a first set of RL model weights from the first agent server, wherein the first set of RL model weights corresponds to a training of a first instance of the master RL agent model on a first graph; and update the master RL agent model based on the first information gain and the first set of RL model weights, thereby generating an updated master RL agent model.

In some embodiments, the central server is further configured to transmit the updated master RL agent model to the first agent server to train the updated master RL agent model on another graph.

In some embodiments, the central server is further configured to: transmit a second instance of the master RL agent model to a second agent server; receive a second information gain from a second gain calculator wherein the second information gain corresponds to a second software stack of a second client; receive a second set of RL model weights from the second agent server, wherein the second set of RL model weights corresponds to a training of the second instance of the master RL agent model on a second graph; and update the master RL agent model based the first information gain, the first set of RL model weights, the second information gain and the second set of RL model weights, thereby generating an updated master RL agent model.

In some embodiments, the central server is further configured to transmit the updated master RL agent model to the first agent server and to the second agent server to each train the updated master RL agent model on another graph, correspondingly.

In some embodiments, the central server is further configured to update the master RL agent model based on the first information gain, the first set of RL model weights, the second information gain and the second set of RL model weights, thereby generating an updated master RL agent model.

In some embodiments, the central server is further configured to combine the first set of RL model weights and the second set of RL model weights to generate a combined set of RL model weights.

In some embodiments, the system further includes a weighted average calculator configured to combine the first set of RL model weights and the second set of RL model weights to generate a combined set of RL model weights. In some embodiments, the weighted average calculator is further configured to update the master RL agent model by applying the combined set of RL model weights.

In some embodiments, the system further includes a weighted average calculator configured to update the master RL agent model by applying a weighted average based on the first information gain and the second information gain.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates a federated learning data privacy system for applying a federated learning framework to preserve siloed client data privacy, according to an example embodiment.

FIG. 2 depicts a cybersecurity method according to an example embodiment.

FIG. 3 depicts a flowchart of a process for providing data privacy using federated learning, according to an example embodiment.

### DETAILED DESCRIPTION

Generally, the example embodiments presented herein are directed to methods, systems and computer program products for using a federated learning design paradigm to achieve data isolation and continuous training of an agent, which are now described herein in terms of an example enterprise system. This description is not intended to limit the application of the example embodiments presented herein. In fact, after reading the following description, it will be apparent to one skilled in the relevant art(s) how to implement the following example embodiments in alternative embodiments, e.g., involving any environment in which assets within the environment can be compromised and using different types of machine learning agents.

A graph as used herein is a mathematical structure used to model pairwise relations between objects. Points are represented as nodes (also referred to sometimes as vertices) that are linked by edges (also referred to sometimes as links). As used herein, a node can represent any type of datapoint associated with a network, technology or organization. An example of a node includes a device, a server, a database, a user, a user group, a network (wired, wireless, etc.), a directory service (e.g., Active Directory), resource, or any other datapoint, system, device or component that can be associated with a network or organization.

Reinforcement learning (RL) as used herein is the training of machine learning models to make a sequence of decisions. The agent learns to achieve a goal in an uncertain, potentially complex environment. In reinforcement learning, an artificial intelligence faces a game-like situation. The computer employs trial and error to come up with a solution to the problem. To get the machine to do what the programmer wants, the artificial intelligence gets either rewards or penalties for the actions it performs. Its goal is to maximize the total reward.

Federated learning (also known as collaborative learning) is a machine learning technique that trains an algorithm across multiple decentralized edge devices or servers holding local data samples, without exchanging them. Federated learning enables multiple actors to build a common, robust machine learning model without sharing data, thus allowing to address critical issues such as data privacy, data security, data access rights and access to heterogeneous data. Federated learning enables training of a high-quality centralized model based on training data distributed over a large number of client computing devices. A federated learning model is a model that learns while not sharing the contributor data. In some embodiments described herein, nodes within a graph are coupled to each other to form a so-called federated learning network. In the federated learning network, node devices can perform separate training of customized machine learning models and then send their local updates (e.g., model gradients or model parameters, collectively called parameter vectors) to a trusted server. The trusted server, in turn, aggregates these local updates to compute global updates. This enables the nodes on the graph (e.g., edge devices) to collaboratively learn a shared prediction model while keeping the training data on the node, decoupling the ability to do machine learning from the need to store the data in, for example, the cloud.

An example embodiment involves using an embedding process to convert a highly unstructured graph data representation into a lower dimensional vector representation of real numbers. In an example embodiment, siloed client graph data is converted to an embedding representation to transform the node, edges, and features into a vector space representation while encoding the graph structure and information that is machine readable.

In turn, the embedding representation is used to calculate an information-theoretic parameter referred to as “information gain”. This metric is a scalar representation that shows the amount of information diversity in the client embedding dataset. In some embodiments, a training event for a reinforcement learning (RL) agent is completed on a dedicated graphics processing unit (GPU) server. The embedding, information gain, and GPU-optimized training are completed in siloed software stacks for each client. The result is an incremental learning process for the RL agent. The learning process generates RL agent model weights (sometimes simply referred to as model weights).

These newly learned agent model weights are communicated to a central server, where deep learning (DL) model weights are averaged out, using the information gain as a weighting factor. In an example embodiment, the model weights are encrypted. Since model weights are sent in transit (and appropriately encrypted) no client graph data is sent or compromised. Only learned information for the RL agent is sent in the transfer.

In some embodiments, generally, the overall process consists of two processes:
Node2Vec embedding generation, where a random element is applied, making the embedding generation process a one-way process.
Training on the embeddings that result from the embedding generation process, resulting in learned model weights/deep learning (DL) parameters, these parameters cannot be reversed without having access to the embeddings and the exact structure of a DL architecture.

The embeddings do not persist outside of each client silo and are replaced upon each interaction by a client with the data. In addition to the model weights, which are encrypted, the information gain parameter is sent in transit (which are also encrypted). This scalar representation of information diversity cannot be reversed to gain access to client graph data.

In some embodiments, each component of information flow, model weights and information gain, are irreversible. During the above process flow, the siloed client data remain separate, thereby preserving client data privacy. Equally important is the fact that GPU resources are optimized. Finally, the RL agent can learn from client data sources in an incremental fashion based on the information gained from client interaction.

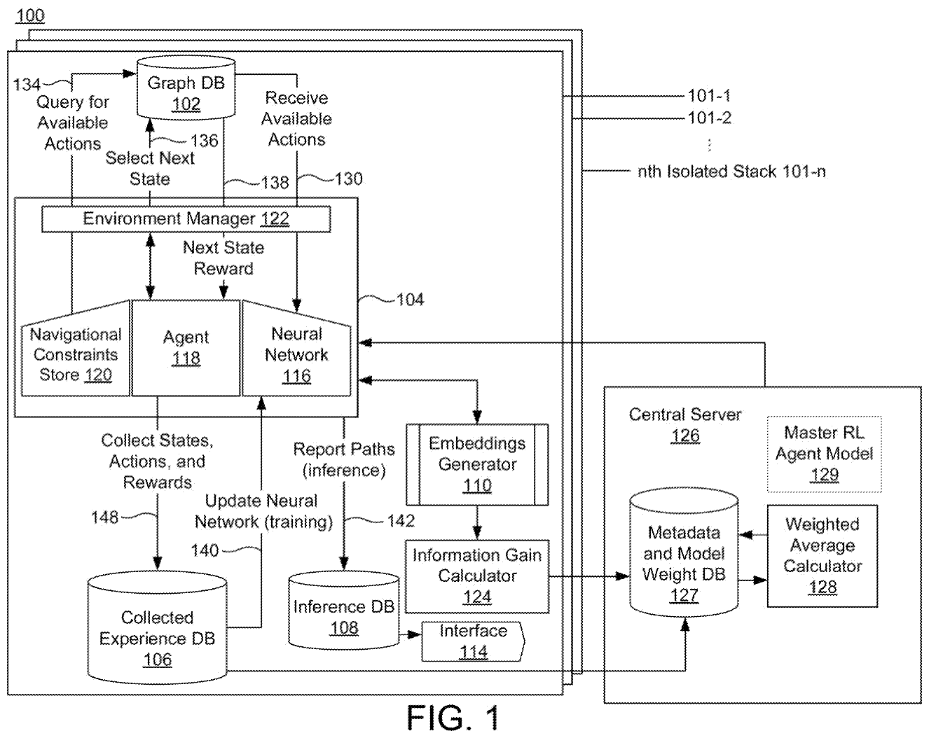

FIG. 1 illustrates an example federated learning data privacy system 100 for applying a federated learning framework to preserve siloed client data privacy. The system includes plural isolated stacks (stack 101-1, stack 101-2, . . . , stack 101-n; individually and collectively referred to as stack 101) and a central server 126.

Each isolated stack includes a graph database 102, an agent server 104, a collected experience database 106, an inference database 108, an embeddings generator 110, and an information gain calculator 124. When applicable an individual component is identified by appending a suffix (e.g., “-1”, “-2”, . . . , “-n”) to distinguish in which software stack the component resides. Agent server 104 includes a neural network 116, an agent 118, a navigational constraints store 120, and an environment manager 122.

Agent 118 mediates through environment manager 122 with a neural network 116 and a set of navigational constraints in navigational constraints store 120. Agent 118 receives its first state from the environment manager 122. Environment manager 122 obtains the first state by querying the graph database 102 for available actions, as shown in step 134. Agent 118 receives from graph database 102 the available actions it can take, as shown in step 130. Agent 118 then determines, from the information it has about the first state and using the neural network 116 along with the navigational constraints stored in navigational constraints store 120, a decision as to what action from the available actions it will take next. At step 136, the agent 118 selects the next state. In turn, the next state reward that results from agent 118 being in the next state is fed back to the agent 118, as shown in step 138. This will repeat until the agent 118 arrives at a terminal state. At that time, agent 118 deposits its experience that it collected in that episode (e.g., states, actions and rewards) into a collected experience database 106 as shown in step 148 or in inference database 108 as shown in step 142. The data that has been stored in collected experience database 106 is used to update the neural network 116 for training purposes, as shown in step 140, and the data that is deposited to inference database 108 (step 142) can be used by other products and services via interface 114.

In some embodiments described herein, nodes within a graph are coupled to each to form federated learning network having associated with it a federated learning model referred to herein as a master RL agent model 129. As will be described in more detail below, in an example embodiment, master RL agent model 129 and neural network 116 share parameters.

Central server 126 includes a metadata and model weight database 127, a weighted average calculator 128 and the master RL agent model 129.

The federated learning data privacy system will now be described in terms of two isolated stacks 101-1 and 101-2. It will be apparent to one skilled in the relevant art(s) how to implement the following example using multiple stacks 101-1, 101-2, . . . , 101-n. Accordingly, in this example, a first agent server 104-1 has a first neural network 116-1. The first agent server 104-1 receives a first instance of a master RL agent model 129, e.g., from central server 126, and trains the first instance of the master RL agent model 129 on one of a plurality of graphs (e.g., obtained from graph DB 102), thereby generating a first set of RL model weights. In an example embodiment, the first set of RL model weights are stored in collected experience database 106-1.

The first information gain calculator 124-1 is communicatively coupled to the first agent server 104-1 (e.g., directly or through embeddings generator 110) and to a central server 126, and is configured to generate a first information gain corresponding to a first software stack 101-1 of a first client and transmit the first information gain to the central server 126. Collected experience database 106 is configured to transmit the first set of RL model weights to the central server 126. Transmitting the first information gain and the first set of RL model weights to the central server 126 enables the central server 126 to update the master RL agent model 129 based on the first information gain and the first set of RL model weights.

The central server 126 is configured to update the master RL agent model 129 based on the first information gain and the first set of RL model weights, thereby generating an updated master RL agent model. When updated, master RL agent model 129 is referred to as an updated master RL agent model.

The first agent server 104-1 is also able to receive an updated master RL agent model. This enables the first neural network 116-1 to train the updated master RL agent model on another graph (e.g., from the plural graphs stored on graph database 102-1).

As described above, federated learning data privacy system 100 can include multiple stacks 101. In some embodiments, federated learning data privacy system 100 includes a second stack 101-2. In this embodiment, a second agent server 104-2 having a second neural network 116-2 is provided. The second agent server 104-2 receives a second instance of the master RL agent model 129 and neural network 116-2 trains the second instance of the master RL agent model 129 on a second graph, thereby generating a second set of RL model weights. A second information gain calculator 124-2 generates a second information gain corresponding to the second software stack 101-2 of a second client. The second information gain calculator 124-2 transmits the second information gain and the second collected experience database 106-2 transmits the second RL model weights to the central server 126, to enable the central server 126 to update the master RL agent model based on the first information gain, the first set of RL model weights, the second information gain and the second set of RL model weights.

In some embodiments, the central server updates the master RL agent model 129 based on the first information gain, the first set of RL model weights, the second information gain and the second set of RL model weights, thereby generating an updated master RL agent model.

In some embodiments, each of the first software stack and the second software stack are siloed.

In some embodiments, weighted average calculator 128 combines the first set of RL model weights and the second set of RL model weights to generate a combined set of RL model weights. The weighted average calculator 128 can, in turn, update the master RL agent model 129 by applying the combined set of RL model weights.

In some embodiments, weighted average calculator 128 updates the master RL agent model 129 by applying a weighted average based on the first information gain and the second information gain.

In some embodiments, the first agent server 104-1 and the second agent server 104-2 are on different systems. In other embodiments, the first agent server 104-1 and the second agent server 104-2 are on the same system.

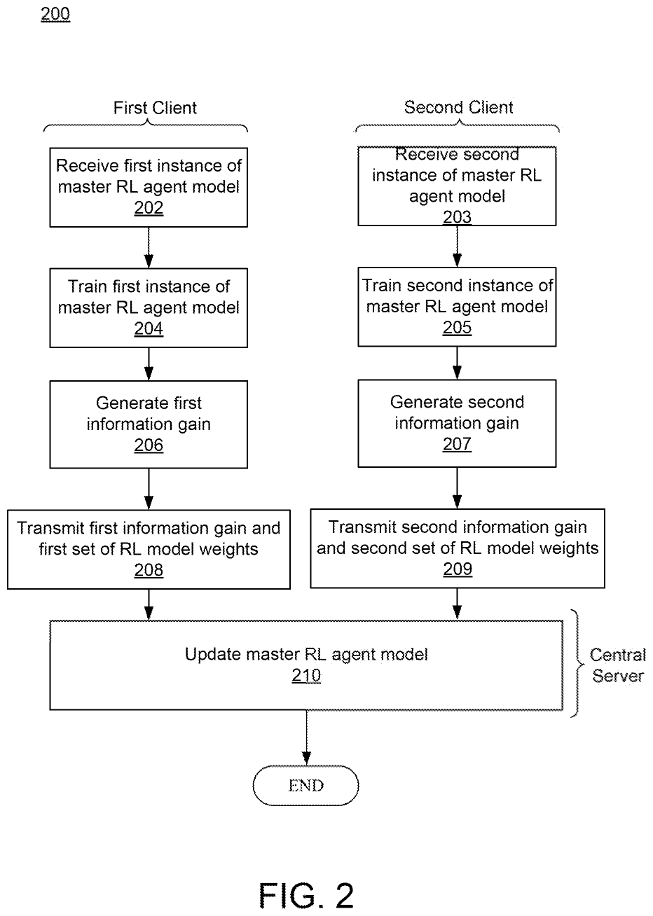

FIG. 2 depicts a flowchart of a process 200 for providing data privacy using federated learning, according to an example embodiment. The method includes receiving a first instance of a master RL agent model, as shown in step 202. At step 204, the method performs training of the first instance of the master RL agent model 129 on a first graph, thereby generating a first set of RL model weights. At step 206, the method performs generating a first information gain corresponding to a first software stack of a first client. The first information gain and the first set of RL model weights are transmitted to a central server, as shown in step 208. This aspect of process 200 enable the central server to update the master RL agent model based on the first information gain and the first set of RL model weights.

In, turn, the master RL agent model 129 is updated (e.g., by central server 126) based on the first information gain and the first set of RL model weights, thereby generating an updated master RL agent model, as shown in step 210.

In the event there exists another software stack 101 of another client, referred to herein as a second software stack 101-2, the method includes receiving a second instance of the master RL agent model 129, as shown in step 203, and training the second instance of the master RL agent model on a second graph, thereby generating a second set of RL model weights, as shown in step 205.

A second information gain corresponding to the second software stack of the second client is generated as shown in step 207. The second information gain and the second RL model weights are, in turn, transmitted to the central server, as shown in step 209, to enable the central server to update the master RL agent model 129 based on the first information gain, the first set of RL model weights, the second information gain and the second set of RL model weights.

In turn, the master RL agent model is updated (e.g., by central server 126) based on the first information gain, the first set of RL model weights, the second information gain and the second set of RL model weights, thereby generating an updated master RL agent model, as shown in step 210.

It should be understood that in some embodiments step 210 is capable of updating the master RL agent model 129 based on the first information gain and the first set of RL model weights and that in some embodiments, step 210 is capable of updating the master RL agent model 129 based on the first information gain, the first set of RL model weights, the second information gain and the second set of RL model weights. Step 210 has been illustrated in this manner for simplicity.

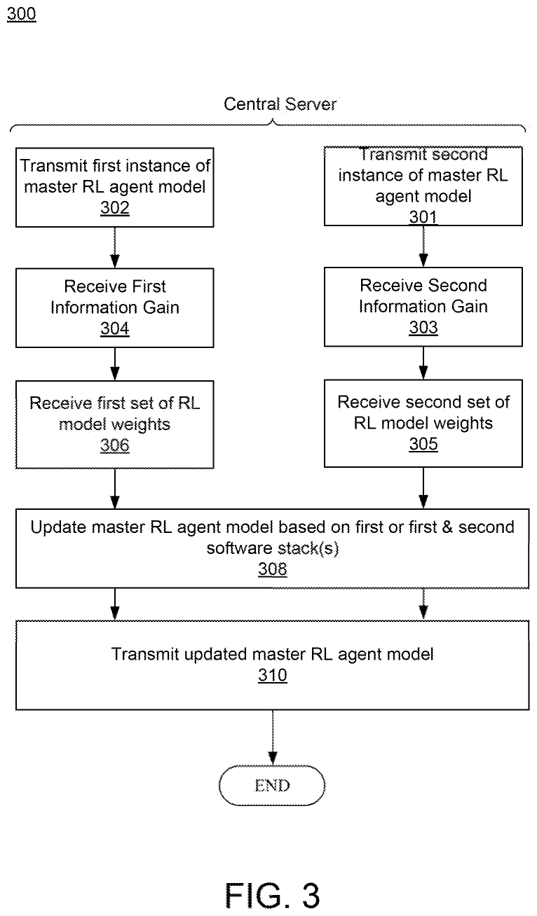

FIG. 3 depicts a flowchart of a process 300 for providing data privacy using federated learning, according to an example embodiment. In step 302, a first instance of a master RL agent model, is transmitted (e.g., by central server 126) to a first agent server 104-1. At step 304, a first information gain is received from a first information gain calculator 124-1. The first information gain corresponds to, for example, a first software stack 101-1 of a first client. At step 306, a first set of RL model weights is received from the first agent server 104-1. The first set of RL model weights corresponds to a training of a first instance of the master RL agent model on a first graph (e.g., in the first software stack 101-1). In turn, the master RL agent model is updated based on the first information gain and the first set of RL model weights, thereby generating an updated master RL agent model, as shown in step 308.

At step 310, the updated master RL agent model is transmitted to the first agent server 104-1 to enable the first agent server 104-1 to train the updated master RL agent model on another graph.

In some embodiments, one or more additional software stacks 101 exist. An additional software stack 101 is referred to as a second software stack 101-2. It should be understood that the present disclosure can be applied to additional software stacks in the same manner.

In some embodiments, a second instance of the master RL agent model 129 is transmitted to a second agent server 104-2, as shown in step 301. At step 303, a second information gain is received from a second gain calculator 124-2. The second information gain corresponds to a second software stack of a second client. In turn, at step 305, a second set of RL model weights from the second agent server 104-2 is received. The second set of RL model weights corresponds to a training of the second instance of the master RL agent model on a second graph (e.g., in the second software stack 101-2). At step 308, the master RL agent model 129 is updated based the first information gain, the first set of RL model weights, the second information gain and the second set of RL model weights, thereby generating an updated master RL agent model.

In turn, at step 310, the updated master RL agent model is transmitted to the first agent server 104-1 and to the second agent server 104-2 to each train the updated master RL agent model on another graph, correspondingly.

It should be understood that in some embodiments, step 310 is capable of transmitting the updated master RL agent model to the first agent server 104-1 and that in other embodiments, step 310 is capable of transmitting the updated master RL agent model to the first agent server 104-1 and the second agent server 104-2. Step 310 has been illustrated in this manner for simplicity.

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application, a voice application, and a video application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

1. A method for providing data privacy using federated learning, comprising:
receiving a first instance of a master RL agent model;
training the first instance of the master RL agent model on a first graph, thereby generating a first set of RL model weights;
generating a first information gain corresponding to a first software stack of a first client; and
transmitting the first information gain and the first set of RL model weights to a central server to enable the central server to update the master RL agent model based on the first information gain and the first set of RL model weights.

2. The method according to claim 1, further comprising:
updating the master RL agent model based on the first information gain and the first set of RL model weights, thereby generating an updated master RL agent model.

3. The method according to claim 1, further comprising:
receiving an updated master RL agent model; and
training the updated master RL agent model on another graph.

4. The method of claim 1, further comprising:
receiving a second instance of the master RL agent model;
training the second instance of the master RL agent model on a second graph, thereby generating a second set of RL model weights;
generating a second information gain corresponding to a second software stack of a second client; and
transmitting the second information gain and the second RL model weights to the central server to enable the central server to update the master RL agent model based on the first information gain, the first set of RL model weights, the second information gain and the second set of RL model weights.

5. The method according to claim 4, further comprising:
updating the master RL agent model based on the first information gain, the first set of RL model weights, the second information gain and the second set of RL model weights, thereby generating an updated master RL agent model.

6. (canceled)

7. The method of claim 4, further comprising:
combining the first set of RL model weights and the second set of RL model weights to generate a combined set of RL model weights.

8. The method according to claim 7, further comprising:
updating the master RL agent model by applying the combined set of RL model weights.

9. The method according to claim 4, further comprising:
updating the master RL agent model by applying a weighted average based on the first information gain and the second information gain.

10. A non-transitory computer-readable medium having stored thereon sequences of instructions, the sequences of instructions including instructions which when executed by a computer system causes the computer system to perform:
receiving a first instance of a master RL agent model;
training the first instance of the master RL agent model on a first graph, thereby generating a first set of RL model weights;
generating a first information gain corresponding to a first software stack of a first client; and
transmitting the first information gain and the first set of RL model weights to a central server to enable the central server to update the master RL agent model based on the first information gain and the first set of RL model weights.

11. The non-transitory computer-readable medium of claim 10, further having stored thereon a sequence of instructions for causing the one or more processors to perform:
updating the master RL agent model based on the first information gain and the first set of RL model weights, thereby generating an updated master RL agent model.

12. The non-transitory computer-readable medium of claim 10, further having stored thereon a sequence of instructions for causing the one or more processors to perform:
receiving an updated master RL agent model; and
training the updated master RL agent model on another graph.

13. The non-transitory computer-readable medium of claim 10, further having stored thereon a sequence of instructions for causing the one or more processors to perform:
receiving a second instance of the master RL agent model;
training the second instance of the master RL agent model on a second graph, thereby generating a second set of RL model weights;
generating a second information gain corresponding to a second software stack of a second client; and
transmitting the second information gain and the second RL model weights to the central server to enable the central server to update the master RL agent model based on the first information gain, the first set of RL model weights, the second information gain and the second set of RL model weights.

14. The non-transitory computer-readable medium of claim 13, further having stored thereon a sequence of instructions for causing the one or more processors to perform:
updating the master RL agent model based on the first information gain, the first set of RL model weights, the second information gain and the second set of RL model weights, thereby generating an updated master RL agent model.

15. (canceled)

16. The non-transitory computer-readable medium of claim 13, further having stored thereon a sequence of instructions for causing the one or more processors to perform:
combining the first set of RL model weights and the second set of RL model weights to generate a combined set of RL model weights.

17. The non-transitory computer-readable medium of claim 16, further having stored thereon a sequence of instructions for causing the one or more processors to perform:
updating the master RL agent model by applying the combined set of RL model weights.

18. The non-transitory computer-readable medium of claim 13, further having stored thereon a sequence of instructions for causing the one or more processors to perform:
updating the master RL agent model by applying a weighted average based on the first information gain and the second information gain.

19. A federated learning data privacy system, comprising:
a first agent server 104-1 having a first neural network configured to:
receive a first instance of a master RL agent model, and
train, by the first neural network the first instance of the master RL agent model on one of a plurality of graphs, thereby generating a first set of RL model weights; and
a first information gain calculator communicatively coupled to the first agent server and to a central server, configured to:
generate a first information gain corresponding to a first software stack of a first client, and
transmit the first information gain and the first set of RL model weights to the central server to enable the central server to update the master RL agent model based on the first information gain and the first set of RL model weights.

20. The system according to claim 19, wherein the central server is configured to update the master RL agent model based on the first information gain and the first set of RL model weights, thereby generating an updated master RL agent model.

21. The system according to claim 19, wherein:
the first agent server is configured to receive an updated master RL agent model; and
the first neural network is configured to train the updated master RL agent model on another one of the plurality of graphs.

22. The system of claim 19, further comprising:
a second agent server having a second neural network, configured to:
receive a second instance of the master RL agent model, and
train the second instance of the master RL agent model on a second graph, thereby generating a second set of RL model weights; and
a second information gain calculator further configured to:
generate a second information gain corresponding to a second software stack of a second client, and
transmit the second information gain and the second RL model weights to the central server to enable the central server to update the master RL agent model based on the first information gain, the first set of RL model weights, the second information gain and the second set of RL model weights.

23. The system according to claim 22, wherein the central server is further configured to update the master RL agent model based on the first information gain, the first set of RL model weights, the second information gain and the second set of RL model weights, thereby generating an updated master RL agent model.

24. (canceled)

25. The system of claim 22, further comprising:
a weighted average calculator configured to combine the first set of RL model weights and the second set of RL model weights to generate a combined set of RL model weights.

26. The system according to claim 25, wherein the weighted average calculator is configured to update the master RL agent model by applying the combined set of RL model weights.

27. The system according to claim 22, further comprising:
a weighted average calculator configured to update the master RL agent model by applying a weighted average based on the first information gain and the second information gain.

28. The system according to claim 22, wherein the first agent server and the second agent server are on different systems.

29. The system according to claim 22, wherein the first agent server and the second agent server are on the same system.

30-53. (canceled)
